(19) United States
(12) Patent Application Publication
(10) Pub. No.: US 2025/0254610 A1
(43) Pub. Date: Aug. 7, 2025

(54) INFORMATION PROCESSING APPARATUS AND METHOD, AND STORAGE MEDIUM STORING PROGRAM

(71) Applicant: CANON KABUSHIKI KAISHA, Tokyo (JP)

(72) Inventor: TOMOYUKI KAWANA, Kanagawa (JP)

(21) Appl. No.: 19/039,602

(22) Filed: Jan. 28, 2025

(30) Foreign Application Priority Data
Feb. 5, 2024 (JP) 2024-015775

(51) Int. Cl. H04W 48/20; H04L 41/22; H04W 24/02; H04W 48/16

(52) U.S. Cl. CPC H04W 48/20; H04L 41/22; H04W 24/02; H04W 48/16

(57) ABSTRACT

An information processing apparatus searches for an access point, displays a search result on a display unit, wherein control is performed to, as part of displaying the search result, display access point information of an access point that has been searched for, and control is performed to display, in a case where a plurality of access points have been searched for, access point information of an access point that is compatible with a predetermined function complying with a communication standard as the search result in preference to access point information of an access point that is not compatible with the predetermined function.

### BACKGROUND

### Field

The present disclosure relates to an information processing apparatus that communicates with an access point, a method in this information processing apparatus, and a storage medium storing a program.

### Description of the Related Art

In recent years, wireless local area network (LAN) techniques have been applied to a variety of devices, where the variety of devices are connected via wireless links. When the variety of devices are connected via wireless links, there are no restrictions on the installation locations of the devices since cables or the like are not used. Thus, a user does not experience any inconveniences. There has been a tendency to construct a wireless LAN environment by arranging an access point (AP) of a wireless LAN in different locations like homes and office environments. Service Set Identifiers (SSIDs) that identify access points and security for protecting wireless communication can be set with respect to access points of a wireless LAN. When searching for access points on a device compatible with a wireless LAN, such as a printer, a display panel or the like mounted on the device displays a list of, for example, SSIDs for identifying access points as a search result. Japanese Patent Laid-Open No. 2015-180106 is seen to discuss that an access point with a high radio wave strength is displayed when the result of the search for access points is displayed. Japanese Patent Laid-Open No. 2022-112729 is seen to discuss that, when displaying the result of the search for access points, an access point that has been set under a predetermined security method is displayed in an easy-to-understand manner.

Wireless LAN techniques include standards such as IEEE 802.11b/11g/11n/11ac/11ax. In recent years, IEEE 802.11be has been launched as a successor standard that aims to further increase throughput, improve the efficiency of use of frequencies, and improve communication latency.

According to the IEEE 802.11be standard, Multi-Link communication has been considered in which, for example, one AP establishes a plurality of links with one station (STA) via a plurality of different frequency channels and communications are performed in parallel. In a case where an AP compatible with Multi-Link communication is used, when Multi-Link communication is performed in an environment with great communication quality, communication throughput can be improved compared to when communication is performed using a single frequency channel.

It is desirable for a communication device to connect to an AP that is in a great communication state and is compatible with Multi-Link communication. However, in a case where there are many surrounding APs, it may be difficult for a user to find a desirable AP from the displayed list of the results of the search for access points.

### SUMMARY

The present disclosure provides an information processing apparatus, method, and storage medium storing a program that improve convenience for a user in a case where a list of access points is displayed on a screen.

According to an aspect of the present disclosure, an information processing apparatus that performs wireless communication with an external access point comprises at least one memory storing a program and at least one processor, that when executing the program, causes the information processing apparatus to search for the access point, display a search result on a display unit, wherein control is performed to, as part of displaying the search result, display access point information of an access point that has been searched for, and to control is performed to display, in a case where a plurality of access points have been searched for, access point information of an access point that is compatible with a predetermined function complying with a communication standard as the search result in preference to access point information of an access point that is not compatible with the predetermined function.

The present disclosure can improve convenience for a user in a case where a list of access points is displayed on a screen.

Further features of the present disclosure will become apparent from the following description of exemplary embodiments with reference to the attached drawings.

### BRIEF DESCRIPTION OF THE DRAWINGS

FIG. 1 is a diagram illustrating a system configuration.

FIG. 2A and FIG. 2B are diagrams illustrating a configuration of a multi-function peripheral (MFP).

FIG. 3A to FIG. 3C are diagrams illustrating an operation display unit of the MFP.

FIG. 4A to FIG. 4D are diagrams illustrating the operation display unit of the MFP.

FIG. 5A to FIG. 5G are diagrams illustrating the operation display unit of the MFP.

FIG. 6A to FIG. 6C are diagrams illustrating pieces of AP attribute information.

FIG. 7A and FIG. 7B are flowcharts illustrating display control processing.

FIG. 8A and FIG. 8B are diagrams illustrating an AP selection screen.

### DESCRIPTION OF THE EMBODIMENTS

Hereinafter, embodiments will be described in detail with reference to the attached drawings. The following embodiments are seen to be limiting. Multiple features are discussed in the below-described embodiments, but not all features are required, and multiple features can be combined as appropriate. Furthermore, in the attached drawings, the same reference numerals are provided to the same or similar configurations, and redundant description thereof is omitted.

### (System Configuration)

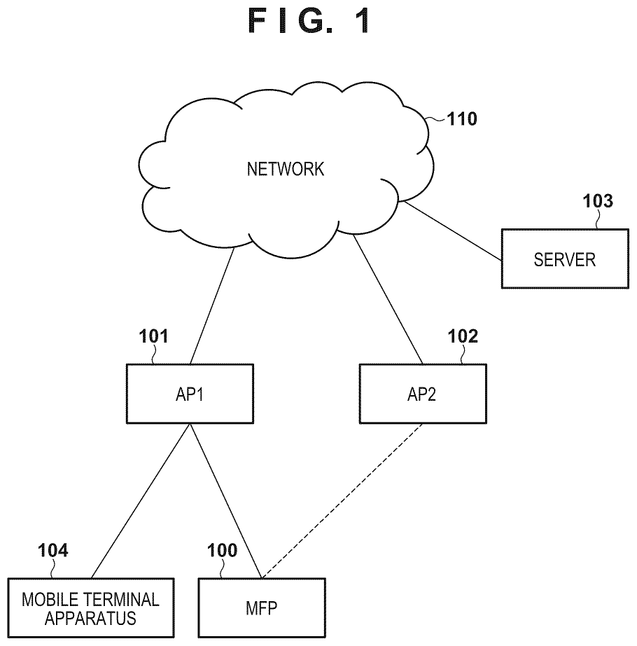

FIG. 1 illustrates an exemplary configuration of a system according to the present embodiment. In one example, the present system is a wireless communication system in which a plurality of communication apparatuses can mutually communicate wirelessly. In the example of FIG. 1, a mobile terminal apparatus 104, an MFP 100, access points AP 101 and AP 102, a server 103, and a network 110 are included as communication apparatuses. The mobile terminal apparatus 104 is an apparatus with a wireless communication function that uses, for example, a wireless LAN. The wireless LAN may be referred to as a WLAN below. The mobile terminal apparatus 104 can be a personal information terminal, such as a personal digital assistant (PDA), a mobile telephone (smartphone), a digital camera, a personal computer, or the like. In the drawings, the access point AP 101 and the access point AP 102 may be denoted by AP1 and AP2, respectively.

The MFP 100 is a print apparatus with a print function, and may further have a read function (a scanner), a FAX function, and a telephone function. The MFP 100 of the present embodiment has a communication function that enables wireless communication with the mobile terminal apparatus 104. While the present embodiment will be described in relation to a case where the MFP 100 is used as one example, no limitation is intended by this. For example, a scanner apparatus, a projector, a mobile terminal, a smartphone, a notebook PC, a tablet terminal, a PDA, a digital camera, a music reproduction device, a television receiver, a smart speaker, or the like with a communication function may be used in place of the MFP 100.

The AP 101 is provided separately external to the mobile terminal apparatus 104 and the MFP 100, and operates as a base station apparatus of the WLAN. A communication apparatus with a WLAN communication function can perform communication in a WLAN infrastructure mode via the AP 101. An access point may hereinafter be referred to as “AP”. An infrastructure mode may be referred to as “wireless infrastructure mode”. The AP 101 performs wireless communication with a (authenticated) communication apparatus that has been permitted to connect thereto, and relays wireless communication between this communication apparatus and another communication apparatus. The AP 101 is connected to, for example, a wired communication network, and can relay communication between a communication apparatus connected to this wired communication network and another communication apparatus wirelessly connected to the AP 101.

The AP 102 represents an AP different from the AP 101, and is arranged in a range in which wireless communication can be performed with the MFP 100, similarly to the AP 101. The MFP 100 can switch a connection destination from the AP 101 to the AP 102 in response to a request for switching a connection destination AP from the AP 101. Access points other than the AP 101 and the AP 102 may exist.

The server 103 connects to the MFP 100 via the AP 101 or the AP 102 and the network 110, and provides a service to the MFP 100 by responding to a request from the MFP 100. The network 110 may be the Internet, or may be a closed, intra-company network or mobile telephone network.

### (Configuration of MFP)

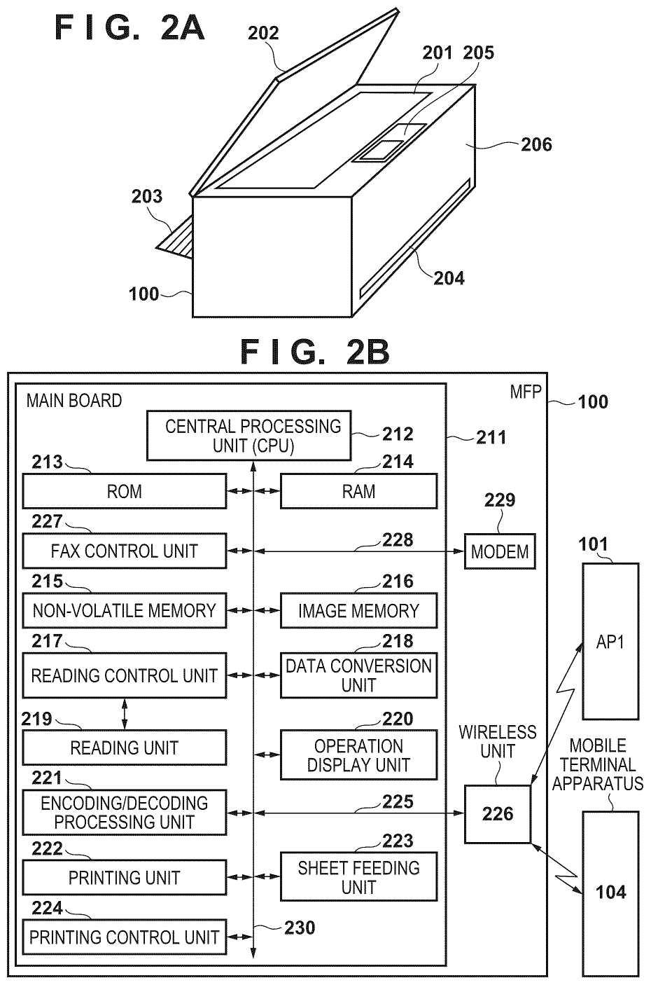

FIG. 2A illustrates an exemplary configuration of the MFP 100. The MFP 100 includes, for example, a platen 201, a document cover 202, a print sheet inlet 203, a print sheet outlet 204, and an operation display unit 205. The platen 201 is a plate on which a document to be read is placed. The document cover 202 presses the document placed on the platen 201, and also prevents light from a light source with which the document is irradiated during reading from leaking out. The print sheet inlet 203 supports sheets of various sizes being set therein. The print sheet outlet 204 discharges sheets on which printing has been completed. Sheets set in the print sheet inlet 203 are conveyed to a print unit one by one, and are discharged from the print sheet outlet 204 after the print unit has performed printing thereon. The operation display unit 205 is configured to include, for example, keys as character input keys, arrow keys, decision keys, and cancel keys, and an LED or an LCD, and can accepts user operations for activation of various types of functions as the MFP and various types of settings. The operation display unit 205 may be configured to include a touch panel display. The MFP 100 has a wireless communication function that uses the WLAN, and is configured to include a wireless communication antenna 206 for this wireless communication. The MFP 100, can perform wireless communication via the WLAN using frequency bands of the 2.4 GHz band, the 5 GHz band, and the 6 GHz band.

FIG. 2B illustrates an exemplary configuration of the MFP 100. The MFP 100 is configured to include a main board 211 that performs control, and a wireless unit 226, which is a single communication module that performs WLAN communication using at least one antenna that is shared between the infrastructure side and the direct side. The MFP 100 is configured to include, for example, a modem 229 for performing wired communication. The main board 211 is configured to include, for example, a central processing unit (CPU) 212, a ROM 213, a RAM 214, a nonvolatile memory 215, an image memory 216, a read control unit 217, a data conversion unit 218, a read unit 219, and an encoding/decoding processing unit 221. The main board 211 includes, for example, a print unit 222, a sheet feeding unit 223, a print control unit 224, and an operation display unit 220. These function units inside the main board 211 are mutually connected via a system bus 230 managed by the CPU 212. The main board 211 and the wireless unit 226 are connected to each other via, for example, a dedicated bus 225, and the main board 211 and the modem 229 are connected to each other via, for example, a dedicated bus 228.

The CPU 212 is a system control unit that includes at least one processor, and controls the MFP 100. In one example, processing of the MFP 100 described below is realized by the CPU 212 executing programs stored in the ROM 213. Items of hardware that are dedicated to respective types of processing may be prepared. The ROM 213 stores control programs executed by the CPU 212, a built-in OS program, and the like. In the present embodiment, software control, such as scheduling and task switching, is performed by the CPU 212 executing each control program stored in the ROM 213 under management of the built-in OS that is similarly stored in the ROM 213.

The RAM 214 is composed of, for example, an SRAM. The RAM 214 stores data such as program control variables, and data such as setting values registered by a user and management data of the MFP 100. The RAM 214 can also be used as various types of working buffers. The nonvolatile memory 215 is composed of, for example, a memory like a flash memory, and keeps storing data even when the power of the MFP 100 has been turned OFF. The image memory 216 is composed of a memory like a DRAM. In the image memory 216, for example, image data received via the wireless unit 226 and image data processed by the encoding/decoding processing unit 221 are accumulated. A memory configuration of the MFP 100 is not limited to the above-described configuration. The data conversion unit 218 performs analysis on data in various formats, conversion from image data into print data, and so forth.

The read control unit 217 optically reads a document placed on the platen 201 by controlling the read unit 219 (e.g., a contact image sensor (CIS)). The read control unit 217 converts an image that has been obtained by optically reading the document into electrical image data (image signals), and outputs the image data. At this time, the read control unit 217 may output the image data after applying thereto various image processing, such as binarization processing and halftone processing.

The operation display unit 220 is the operation display unit 205 that has been described with reference to FIG. 2A, and executes presentation on a display that is based on display control performed by the CPU 212, generation of signals in response to acceptance of a user operation, and so forth. The encoding/decoding processing unit 221 executes encoding processing, decoding processing, and enlargement/reduction processing with respect to image data (JPEG, PNG, and the like) handled by the MFP 100.

The sheet feeding unit 223 stores sheets for printing. Under control of the print control unit 224, the sheet feeding unit 223 can feed sheets set in a cassette. The sheet feeding unit 223 may include a plurality of sheet feeding units to store a plurality of types of sheets in one apparatus, and can control from which sheet feeding unit the sheets are to be fed under control of the print control unit 224. The print control unit 224 applies various types of image processing, such as smoothing processing, print density correction processing, and color correction, to the image data to be printed, and outputs the image data after the processing to the print unit 222. The print unit 222 is executes, for example, print processing of an inkjet recording method, causes a print head to eject ink supplied from an ink tank, and records an image on a recording medium, such as a sheet. The print unit 222 may be configured to execute other print processing of an electrophotographic method or the like. The print control unit 224 can periodically read out information of the print unit 222 and update, for example, status information which is stored in the RAM 214 and which includes the remaining ink level in the ink tank, the state of the print head, and the like.

The wireless unit 226 is a unit providing a WLAN communication function. Based on the WLAN communication standards, the wireless unit 226 converts data into packets, transmits the packets to another device, restores packets from another external device into original data, and outputs the original data to the CPU 212. The wireless unit 226 can perform communication as a station complying with the IEEE 802.11 standard series. The wireless unit 226 can perform communication as a station complying with the IEEE 802.11a/b/g/n/ac/ax/be. Hereinafter, a station may be referred to as an STA. The wireless unit 226 can perform communication as an STA that is compatible with the IEEE 802.11be, namely Wi-Fi 7™, and is compatible with Multi-Link. According to the IEEE 802.11be standard, Multi-Link communication has been considered in which, for example, one AP establishes a plurality of links with one STA via a plurality of different frequency channels, and communications are performed in parallel.

The mobile terminal apparatus 104 and the MFP 100 can perform P2P (WLAN) communication that is based on Wi-Fi Direct® (WFD), and the wireless unit 226 has a software access point (software AP) function or a group owner function. The wireless unit 226 can construct a P2P communication network, and determine a channel to be used in P2P communication.

### (Operation Display Unit of MFP)

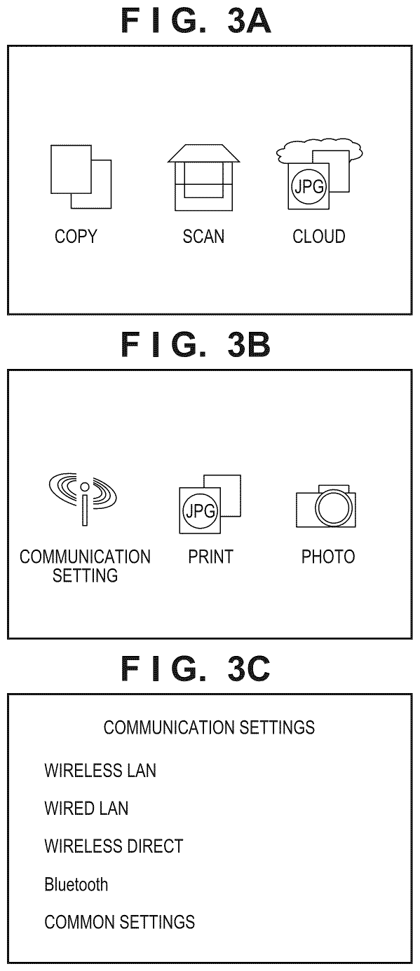

FIG. 3A to FIG. 3C schematically illustrate examples of a screen displayed on the display (touch panel display) included in the operation display unit 220 of the MFP 100. FIG. 3A is an example of a home screen displayed during a state where the power of the MFP 100 is ON and such operations as printing and scanning are not performed (an idle state or a standby state). In FIG. 3A, display items (menu items) that respectively correspond to copy, scan, and cloud are displayed. The cloud is a menu item related to a cloud function that uses Internet communication. When one of the menu items has been selected by a key operation or a touch panel operation, the MFP 100 can execute and start a corresponding setting or function. The MFP 100 can seamlessly display a screen different from FIG. 3A by accepting a key operation or a touch panel operation on the home screen of FIG. 3A.

FIG. 3B is a display example of another part of the home screen, and is a screen to which the state of FIG. 3A transitions when an operation of displaying another page of the home screen (e.g., a leftward or rightward slide operation) has been performed. In FIG. 3B, display items (menu items) that respectively correspond to communication settings, print, and body settings are displayed. When one of these menu items has been selected, a function corresponding to the selected menu item, such as the communication settings, print function, and body settings, is executed.

FIG. 3C is a display example of a menu screen of the communication settings that is displayed in a case where the communication settings have been selected on the screen of FIG. 3B. The menu screen of the communication settings displays “wireless LAN”, “wired LAN”, “wireless direct”, “Bluetooth”, and “common settings” as menu items (options). “Wireless LAN”, “wired LAN”, and “wireless direct” are menu items for configuring LAN settings; such settings as settings of wired connection, a setting to enable/disable the wireless infrastructure mode, and a setting to enable/disable the P2P mode, like WFD and the software AP mode, can be configured from these items. For example, in a case where the item “wireless LAN” has been selected and the wireless LAN has been set to be enabled by a user operation, the wireless infrastructure mode is enabled. In a case, for example, where the item “wireless direct” has been selected and wireless direct has been set to be enabled by a user operation, the P2P (WLAN) mode is enabled. This screen also displays a common setting menu related to each form of connection. In addition, the user can, for example, set the frequency bands and frequency channels of the wireless LAN from this screen.

### (Method of Setting Multi-Link Function)

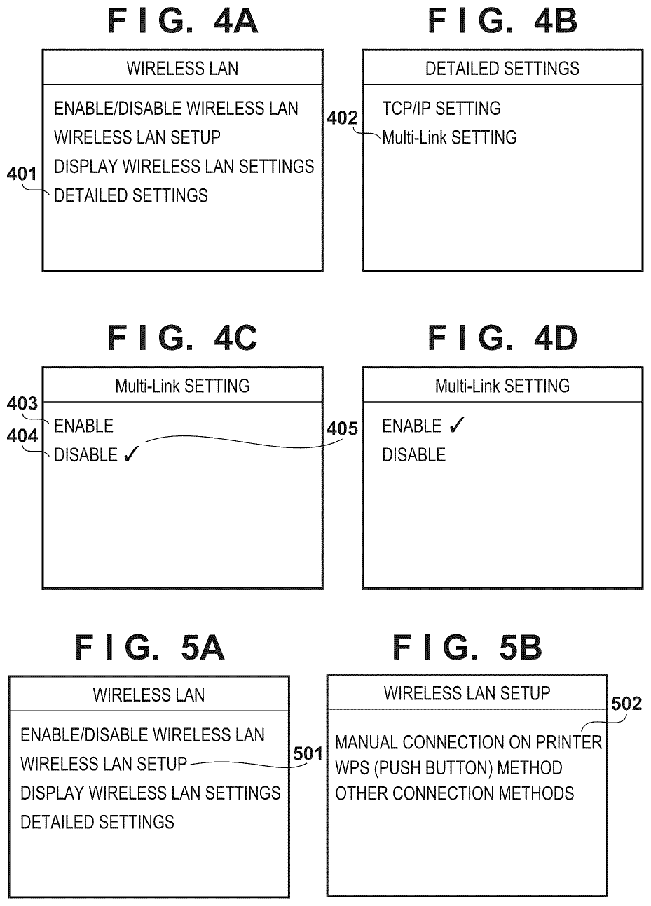

FIG. 4A to FIG. 4D are explanatory diagrams of a method of setting a Multi-Link function of the MFP 100. An AP and a station (STA) execute Multi-Link communication where they establish links via a plurality of frequency channels and perform communication. Multi-Link is defined in the IEEE 802.11 standards. An AP that executes Multi-Link communication is also referred to as an AP MLD. According to the standards of the IEEE 802.11 series, the bandwidth of each frequency channel is defined as 20 MHz. Here, frequency channels denote frequency channels defined in the standards of the IEEE 802.11 series; the standards of the IEEE 802.11 series define a plurality of frequency channels in each of frequency bands of the 2.4 GHz band, the 5 GHz band, the 6 GHz band, and the 60 GHz band. A single frequency channel may use a bandwidth of 40 MHz or more by bonding with a neighboring frequency channel. For example, the AP 101 can perform communication with the STA by establishing a link therewith via a first frequency channel in the 5 GHz band. In parallel with this, the STA can perform communication with the AP 101 by establishing a link therewith via a second frequency channel in the 6 GHz band. In this case, the STA executes Multi-Link communication where a second link via the second frequency channel is maintained in parallel with a link via the first frequency channel.

Conventionally, an STA compatible with the IEEE 802.11 standards connects to an access point and performs data communication with the access point via a single link. An increase in throughput can be realized by connecting to an access point and performing data communication via two or more links simultaneously in Multi-Link communication. According to 11be, supporting of the 6 GHz band is also considered to expand usable frequency bands. The two or more links may be selected from the same frequency band (one of the sub-GHz band, the 2.4 GHz band, the 3.6 GHz band, the 4.9 and 5 GHz band, the 60 GHz band, and the 6 GHz band), or may be selected respectively from different frequency bands. An AP and an STA compatible with Multi-Link communication are referred to as an AP Multi-Link device (MLD) and an STA MLD. APs that are associated with an AP MLD and operate in different channels are referred to as affiliated APs, and STAs that are associated with an STA MLD and operate in different channels are referred to as affiliated STAs. The affiliated APs and the affiliated STAs are expressed with numbers appended at the end, such as AP1, AP2, . . . , and STA1, STA2, . . . . As described above, the AP 101 establishes links with the STA via a plurality of frequency channels. This enables throughput in communication with the STA to be increased. Tegarding links between discrete communication devices, a plurality of links in different frequency bands may be established in Multi-Link communication. For example, the AP 101 and the STA may establish a third link in the 2.4 GHz band in addition to a link in the 5 GHz band and a link in the 6 GHz band. Alternatively, links may be established via a plurality of different channels included in the same frequency band. For example, channel 15 in the 6 GHz band may be established as a first link, and in addition, channel 207 in the 6 GHz band may be established as a second link. Links in the same frequency band and links in different frequency bands may coexist. For example, the AP 101 and the STA may establish a link of channel 149 in the 5 GHz band and a link of channel 15 in the 6 GHz band, in addition to a link of channel 36 in the 5 GHz band. When the AP 101 has established a plurality of connections of different frequencies with the STA, even if a certain band is congested, communication can be established with the STA 102 in another band. This can prevent a decrease in throughput and a communication delay in communication with the STA.

FIG. 4A is a wireless LAN setting screen that is displayed when “wireless LAN” has been selected on the menu screen of the communication settings of FIG. 3C. The wireless LAN setting screen displays “enable/disable wireless LAN”, “set up wireless LAN”, “display wireless LAN settings”, and “detailed settings” as menu items. Here, upon selection of “detailed settings” under a menu item 401, a screen of FIG. 4B is displayed.

FIG. 4B is a screen of detailed settings of the wireless LAN. The screen of detailed settings of the wireless LAN displays “TCP/IP setting” and “Multi-Link setting” as menu items. Here, upon selection of “Multi-Link setting” under a menu item 402, a screen of FIG. 4C is displayed.

FIG. 4C is a Multi-Link setting screen. The Multi-Link setting screen displays “enable” under an option 403 and “disable” under an option 404 as options; by selecting one of them, the user can switch between an enabled state and a disabled state of the Multi-Link function of the MFP 100. A setting value of the enabled or disabled state of the Multi-Link function is stored in the nonvolatile memory 215. When displaying FIG. 4C, the operation display unit 220 reads out this setting value from the nonvolatile memory 215, and displays a check mark 405 at the current setting value. In FIG. 4C, that the check mark 405 indicates that the Multi-Link function is currently disabled. Here, if “enable” under an option 403 is selected, a transition is made to a screen state of FIG. 4D, and the operation display unit 220 stores “enable” as the Multi-Link setting value in the nonvolatile memory 215.

When the Multi-Link setting is enabled, the MFP 100 acts as an STA compatible with Multi-Link (referred to as a Multi-Link-compatible STA). In a case where it has established links with an AP compatible with Multi-Link (referred to as a Multi-Link-compatible AP) in the Multi-Link mode in this state, Multi-Link communication can be performed. Multi-Link communication becomes possible in which a plurality of links are established between one AP and one STA and communications are performed in parallel. In a case where links have been established with a Multi-Link-compatible AP in a non-Multi-Link mode, communication is performed via a single frequency channel. When the Multi-Link setting has been disabled, the MFP 100 acts as a Multi-Link-incompatible STA, and connects to a Multi-Link-compatible AP via a single frequency channel.

### (Wireless Connection Method)

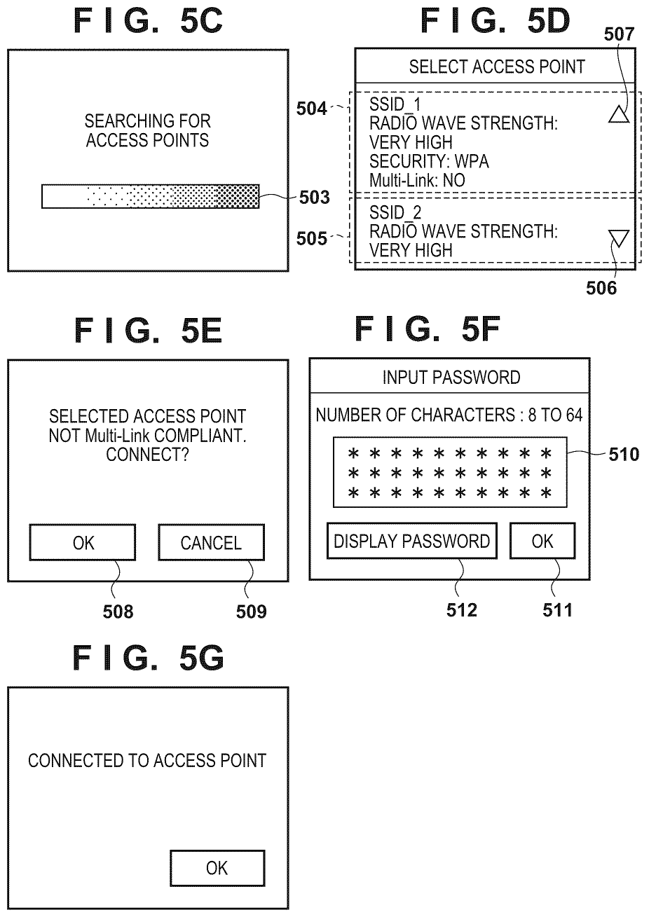

FIG. 5A to FIG. 5G are explanatory diagrams related to a wireless connection method of the MFP 100. FIG. 5A to FIG. 5G illustrate a flow of a series of contents displayed on the operation display unit 220 when wireless connection is performed. FIG. 5A is a wireless LAN setting screen that is displayed when “wireless LAN” has been selected on the menu screen of the communication settings of FIG. 3C. FIG. 5A is the same screen as FIG. 4A. The wireless LAN setting screen displays “enable/disable wireless LAN”, “set up wireless LAN”, “display wireless LAN settings”, and “detailed settings” as menu items. Here, upon selection of “set up wireless LAN” under a menu item 501, a wireless LAN setup screen of FIG. 5B is displayed. The wireless LAN setup screen displays “manual connection on printer”, “WPS (push-button) method”, and “other connection methods” as menu items. Here, upon selection of “manual connection on printer” under a menu item 502, a screen of FIG. 5C is displayed. At this time, the MFP 100 searches for surrounding APs using the wireless unit 226. A progress bar 503 indicates that search processing is currently executed, and enables the user to confirm that the processing is not halted. When the AP search has been completed, the search results are displayed.

FIG. 5D illustrates an AP selection screen that displays the AP search results. The AP selection screen displays a list of pieces of access point information (AP information) of APs that have been searched for. An AP information area 504 is an AP information area indicating one piece of AP information. The AP information area is configured to include an SSID representing an identifier of an AP, a radio wave strength, security type information, and information on whether the AP is compatible with Multi-Link. The SSID is an arbitrary character string set for the AP. The radio wave strength is a communication quality rank, which will be described below. The security type information is a character string, such as “WEP”, “WPA”, WPA2″, and “WPA3”. Note that WEP is an acronym for Wired Equivalent Privacy, and WPA is an acronym for Wi-Fi Protected Access. Character strings “YES” and “NO” are displayed as Multi-Link compatibility information in a case where the AP is compatible with Multi-Link and in a case where the AP is not compatible with Multi-Link, respectively. Although AP information includes the SSID, the radio wave strength, the security information, and the Multi-Link compatibility information in the present example, it may include other pieces of AP attribute information.) the pieces of information may be included as long as they are information included in a response to an AP search request. The foregoing Multi-Link compatibility information is obtained based on, for example, the Basic Multi-Link element included in the Probe Response from the AP. While the foregoing configuration determines whether an AP is compatible with Multi-Link, no limitation is intended by this. For example, it is permissible to adopt a configuration that determines whether an AP is an AP compatible with the standard of or after the IEEE 802.11be. In this case, it is determined that an AP is compatible with the standard of or after the IEEE 802.11be based on information indicating compatibility with the standard of or after the IEEE 802.11be.

In an AP information area 505, which is an AP information area similarly to the AP information area 504, a part of AP information is hidden due to a restriction on the number of rows displayed by the operation display unit 220. The hidden part can be displayed by scrolling the screen. Scroll buttons provided for this reason are a down scroll button 506 and an up scroll button 507. By selecting these buttons, the user can confirm pieces of information of all APs that have been searched for. When the user has selected any AP information area, the MFP 100 makes a transition to processing for connection to the selected AP.

FIG. 5E is a confirmation screen providing a notification indicating that a Multi-Link-incompatible AP has been selected. Prior to the processing for connection to an AP, in a case where the Multi-Link function has been enabled and the AP search results include a Multi-Link-compatible AP, the MFP 100 displays a confirmation screen for the user when the user has selected a Multi-Link-incompatible AP. The purpose of this is to suggest the possibility of the user's mistake in AP selection. Here, selecting a cancel button 509 returns to the AP selection screen of FIG. 5D. If an OK button 508 is selected, the MFP 100 displays a password input screen that causes the user to input connection information, such as a passphrase of the AP selected in FIG. 5D.

FIG. 5F is a password input screen at the time of AP connection processing (the expression “password” used here is synonymous with “passphrase”). A restriction on a password, such as the number of characters, varies depending on the security type of the AP; thus, the MFP 100 displays a screen corresponding to the security of the selected AP. The present example pertains to a password input screen for a case where the security type of the AP is “WPA2”. While the methods of inputting characters to a character input area 510 generally include, for example, a method that uses a software keyboard screen, a detailed description is omitted here. During inputting of the password, the characters that are currently input are replaced with “*” (asterisks) (a method called masked characters) to prevent others from reading the characters. However, selecting a password display button 512 causes the input characters to be displayed. Once the password has been input and an OK button 511 has been selected, the MFP 100 attempts wireless connection to the selected AP based on the input connection information. When the MFP 100 has succeeded in the wireless connection, a connection completion screen of FIG. 5G is displayed to provide notice of the completion of the connection. Via the above-described operations, the MFP 100 can communicate with an external terminal in a network provided by the connected AP, and with an external terminal in another network that is mutually connected to this network.

### (Display Order of Pieces of AP Information)

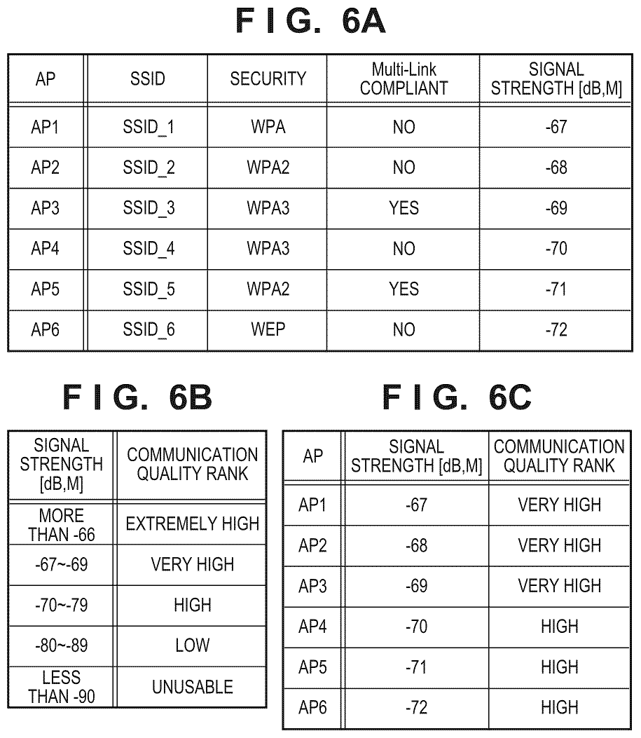

FIG. 6A to FIG. 6C are diagrams illustrating examples of pieces of AP attribute information of an AP group according to the present embodiment. FIG. 6A illustrates pieces of AP information that the MFP 100 obtains from the respective APs. An AP column represents AP numbers. As a result of performing the AP search, the MFP 100 discovers six APs, namely AP1 to AP6, and obtains pieces of information thereof from, for example, Beacon signals of the respective APs. An SSID column represents identifiers of the APs. A security column illustrates security settings of the APs, and the types thereof include WEP, WPA2, and WPA3. The strength of security is highest for WPA3, decreases for WPA2 and WPA in this order, and is lowest for WEP. A Multi-Link compatibility column indicates whether APs are compatible with the Multi-Link function. “YES” and “NO” mean compatible and incompatible, respectively. A signal strength column indicates the strengths of radio wave signals arriving at the MFP 100 from the respective APs. The unit thereof is decibels relative to a milliwatt (dBm), meaning that the smaller the value, the lower the signal strength. From among the APs in the table, AP1 has the highest signal strength and AP6 has the lowest signal strength.

FIG. 6B is a diagram illustrating an example of correspondence between the signal strength and the communication quality rank on the MFP 100. The communication quality ranks are brought into correspondence with signal strength ranges based on reliability and desirability of communication. In general, a desirable signal strength varies depending on the intended use and the purpose of a communication device. Thus, merely one example is illustrated. On the MFP 100, the communication quality rank of a signal strength equal to or higher than −66 dBm is considered to be “extremely high”. The communication quality rank of a signal strength in the range of −67 dBm to −69 dBm is considered to be “very high”. The communication quality rank of a signal strength in the range of −70 dBm to −79 dBm is considered to be “high”. The communication quality rank of a signal strength in the range of −80 dBm to −89 dBm is considered to be “low”. The communication quality rank of a signal strength equal to or lower than −90 dBm is considered to be “unusable”.

FIG. 6C is a table illustrating the communication quality ranks of the respective APs on the MFP 100. The MFP 100 determines the communication quality ranks of the respective APs based on the signal strengths of the respective APs illustrated in FIG. 6A, and on the correspondence between the signal strength and the communication quality rank illustrated in FIG. 6B. As the signal strengths of AP1, AP2, and AP3 are categorized in the range of −67 dBm to −69 dBm illustrated in FIG. 6B, the MFP 100 determines the communication quality ranks thereof to be “very high”. As the signal strengths of AP4, AP5, and AP6 are categorized in the range of −70 dBm to −79 dBm illustrated in FIG. 6B, the MFP 100 determines the communication quality ranks thereof to be “high”.

Next, a description will be provided of display control processing executed by the MFP 100 to control display of the AP search results.

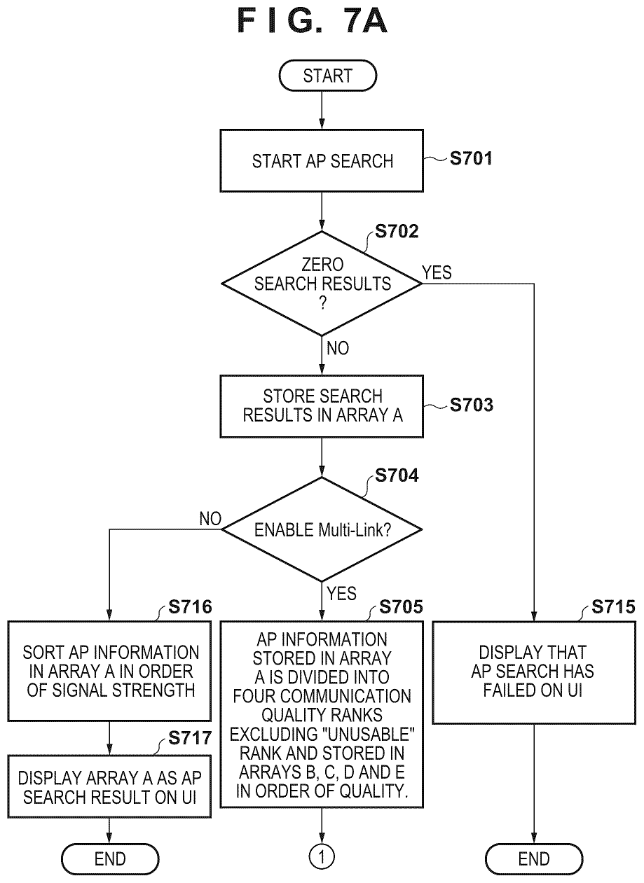

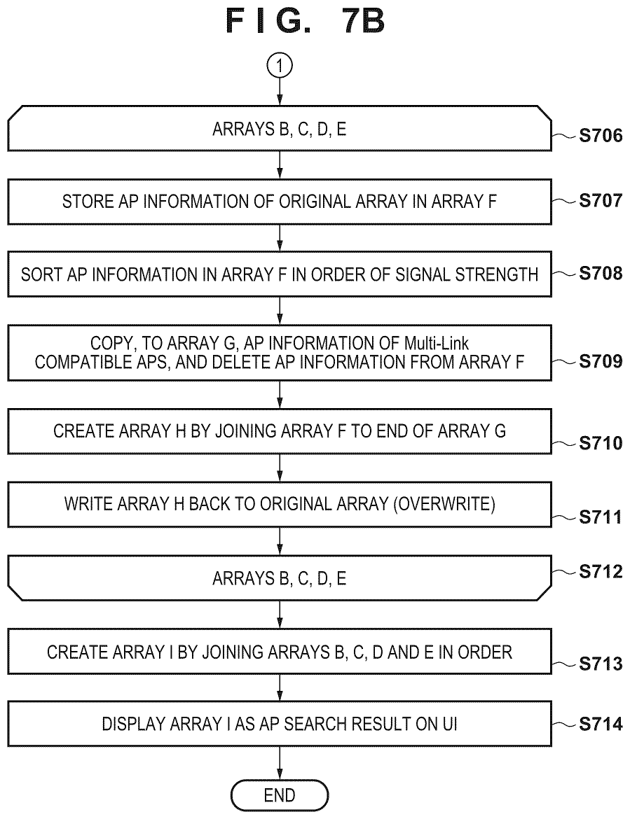

FIG. 7A and FIG. 7B are flowcharts illustrating the display control processing according to the present embodiment. The flowcharts of FIGS. 7A and 7B are realized by the CPU 212 reading out a program stored in the ROM 213 into the RAM 214 and executing the program. The flowcharts of FIGS. 7A and 7B are started, for example, in a case where “manual connection on printer” under the menu item 502 of FIG. 5B has been selected. The flowcharts of FIGS. 7A and 7B are started in a case where the setting for searching for surrounding APs has been selected, rather than a case where “manual connection on printer” has been selected. It is assumed here that the Multi-Link setting has been enabled using the setting screens of FIG. 4B, FIG. 4C, and FIG. 4D.

In step S701, the CPU 212 searches for surrounding APs using the wireless unit 226. Next, in step S702, the CPU 212 determines whether the search has succeeded. Specifically, for example, in a case where there are no surrounding APs that transmit a Beacon signal, there are 0 search results, it is determined that the search has failed, and processing proceeds to step S715. In step S715, the CPU 212 presents, on the operation display unit 220, a display indicating that the AP search has failed. Thereafter, processing of the present flowchart ends. In a case where it is determined that the search has succeeded, the CPU 212 stores pieces of AP information of an AP group that has been searched for in an array A secured in the RAM 214 in step S703.

Next, in step S704, the CPU 212 reads out Multi-Link setting information from the nonvolatile memory 215, and determines whether the Multi-Link function has been set to be enabled. In a case where it is determined that the Multi-Link function has not been set to be enabled, processing proceeds to step S716. In step S716, the CPU 212 executes processing for rearranging the AP group stored in the array A in descending order of signal strength. This processing uses, for example, bubble sort. Next, in step S717, the CPU 212 displays the array A on the operation display unit 220 as the AP search results, and then ends processing of the present flowchart.

As described above, in a case where the Multi-Link function has not been set to be enabled on the MFP 100, the pieces of AP information of the AP group that has been searched for can be displayed in descending order of signal strength, and the user can easily look up an AP with great communication quality.

In a case where the Multi-Link function has been set to be enabled in step S704, processing proceeds to step S705, and the CPU 212 rearranges the AP search results using Multi-Link compatibility/incompatibility information included in the pieces of AP information. As one example, the following description will be provided under the assumption that the APs of FIG. 6A have been searched for as the pieces of AP information, and the table of FIG. 6B is used as the communication quality ranks.

In step S705, the CPU 212 further groups the pieces of AP information stored in the array A into four communication quality ranks excluding the “unusable” rank, and stores them in arrays B, C, D, and E secured in the RAM 214. The arrays B to E correspond to the order of the communication quality ranks. The pieces of AP information whose communication quality ranks are “extremely high” are stored in the array B. The pieces of AP information whose communication quality ranks are “very high” are stored in the array C. The pieces of AP information whose communication quality ranks are “high” are stored in the array D. The pieces of AP information whose communication quality ranks are “low” are stored in the array E. Specifically, for example, the pieces of AP information of AP1, AP2, and AP3 are stored in the array C, and the pieces of AP information of AP4, AP5, and AP6 are stored in the array D.

Steps S706 and S712 indicate that the CPU 212 repeats processing of steps S707 to S711 with respect to each of the arrays B, C, D, and E. As the pieces of AP information of the six APs that are exemplarily illustrated in FIG. 6C do not include pieces of AP information whose communication quality ranks are “extremely high” or “low”, no AP information is stored in the array B and the array E. Therefore, processing of steps S707 to S711 is not executed with respect to the arrays B and E.

In step S707, the CPU 212 first stores pieces of AP information in the array targeted for the current repetitive processing in an array F. Specifically, for example, focusing on the array C as the array targeted for the current repetitive processing, the pieces of AP information of AP1, AP2, and AP3 in the array C are stored in the array F.

Next, in step S708, the CPU 212 sorts the pieces of AP information in the array F in the order of signal strength. This processing uses, for example, bubble sort. In the foregoing example, the result of sorting the array F is AP1, AP2, and AP3 in this order based on the signal strengths illustrated in FIG. 6C.

Next, in step S709, the CPU 212 copies, to an array G, pieces of AP information of Multi-Link compatible APs among the pieces of AP information included in the array F, and deletes these pieces of AP information from the array F. According to the Multi-Link compatibility/incompatibility information of FIG. 6A, AP3 and AP5 are compatible with the Multi-Link function, whereas AP1, AP2, AP4, and AP6 are not compatible with the Multi-Link function. Therefore, in the foregoing example, the AP information of AP3 is copied to the array G, and the AP information of AP3 is deleted from the array F.

Next, in step S710, the CPU 212 creates an array H by joining the array F to the end of the array G. To describe this using the foregoing example, as a result of step S710, the array H is created in which the pieces of AP information of AP3, AP1, and AP2 are stored in this order.

Next, in step S711, the CPU 212 overwrites the original array, i.e., the array targeted for the current repetitive processing, with the array H. In the foregoing example, the array C is overwritten with the array H. As a result, the array C turns into an array of AP3, AP1, and AP2 in this order. Sorting is performed so that, from among the APs whose communication quality ranks are “very high”, the APs compatible with the Multi-Link function are ranked high in the array.

This concludes rearrangement processing for APs with one communication quality rank. Subsequently, the CPU 212 similarly repeats processing of steps S707 to S711 with respect to the arrays with other communication quality ranks. Before this repetition, the arrays F, G, and H are cleared. In the foregoing example, the CPU 212 focuses on the array D as an array targeted for the current repetitive processing, and stores the pieces of AP information of AP4, AP5, and AP6 in the array D into the array F in step S707. Then, in step S708, the CPU 212 sorts the pieces of AP information in the array F in the order of signal strength. The result of this sorting is AP4, AP5, and AP6 in this order based on the signal strengths illustrated in FIG. 6C. In step S709, the CPU 212 copies, to the array G, pieces of AP information of Multi-Link compatible APs among the pieces of AP information included in the array F, and deletes these pieces of AP information from the array F. As a result, the AP information of AP5 is copied to the array G, and the AP information of AP5 is deleted from the array F. In step S710, the CPU 212 creates an array H by joining the array F to the end of the array G. As a result of, the array H is created in which the pieces of AP information of AP5, AP4, and AP6 are stored in this order. In step S711, the CPU 212 overwrites the original array, i.e., the array targeted for the current repetitive processing, with the array H. As a result, the array D turns into an array of AP5, AP4, and AP6 in this order. Sorting is performed so that, among the APs whose communication quality ranks are “high”, the APs compatible with the Multi-Link function are ranked high in the array. When processing has finished for every array, processing proceeds to step S713.

In step S713, the CPU 212 creates an array I by joining the arrays B, C, D, and E in this order. In the foregoing example, the array I is created by joining the arrays C and D in this order. In the foregoing example, the created array I includes AP3, AP1, AP2, AP5, AP4, and AP6 in this order.

In step S714, the CPU 212 displays the AP search results on the operation display unit 220 based on the array I, and then ends processing of the present flowchart.

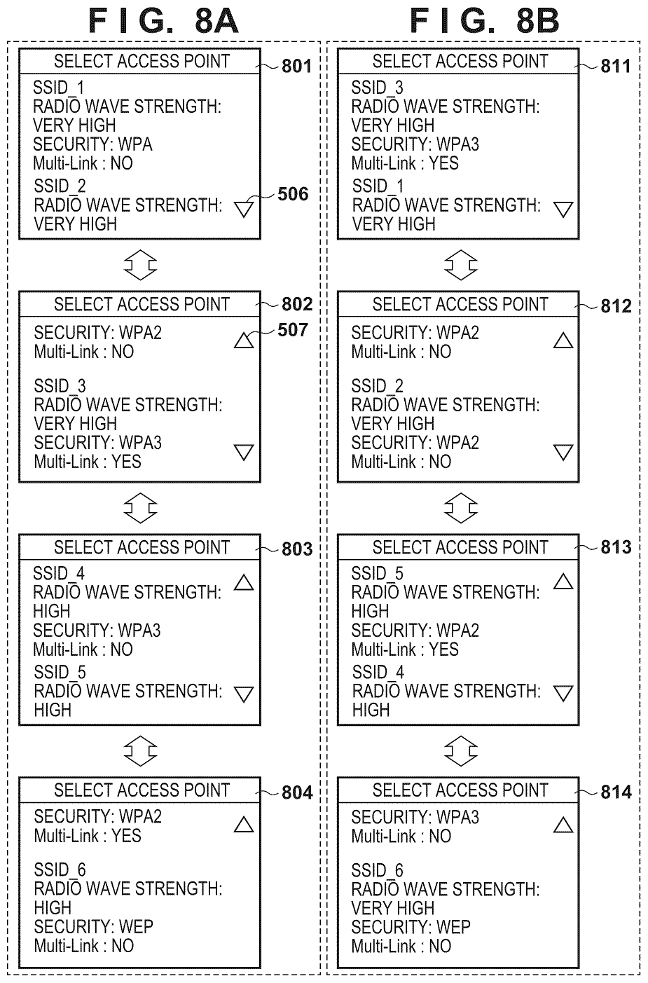

FIG. 8A and FIG. 8B are diagrams illustrating examples of an AP selection screen that displays the AP search results on the MFP 100. FIG. 8A is an AP selection screen of the operation display unit 220 for a case where the Multi-Link function of the MFP 100 has been set to be disabled. This is equivalent to the screen displayed in step S717 of FIG. 7A.

An AP search screen 801 is a screen at the beginning of the AP search results. An AP search screen 802 is a screen of a lower region that follows the AP search screen 801. An AP search screen 803 is a screen of a lower region that follows the AP search screen 802. An AP search screen 804 is a screen of a lower region that follows the AP search screen 803. Selecting a down scroll button 506 or an up scroll button 507 causes each screen to make a transition. As illustrated on the AP search screen 801 to the AP search screen 804, the SSIDs of the pieces of AP information are in the following order, from the top: “SSID_1”, “SSID_2”, “SSID_3”, “SSID_4”, “SSID_5”, and “SSID_6”. This is the order of AP1, AP2, AP3, AP4, AP5, and AP6 in the AP column illustrated in FIG. 6A, i.e., they are listed in the order of signal strength.

FIG. 8B is an AP selection screen of the operation display unit 220 for a case where the Multi-Link function of the MFP 100 has been set to be enabled. This is equivalent to the screen displayed in step S714 of FIG. 7B. An AP search screen 811 is a screen at the beginning of the AP search results. An AP search screen 812 is a screen of a lower region that follows the AP search screen 811. An AP search screen 813 is a screen of a lower region that follows the AP search screen 812. An AP search screen 814 is a screen of a lower region that follows the AP search screen 813. Selecting a down scroll button 506 or an up scroll button 507 causes each screen to make a transition. From the AP search screen 811 through to the AP search screen 814, the SSIDs of the pieces of AP information are in the following order, from the top: “SSID_3”, “SSID_1”, “SSID_2”, “SSID_5”, “SSID_4”, and “SSID_6”. This corresponds to the order of AP3, AP1, AP2, AP5, AP4, and AP6 in the AP column illustrated in FIG. 6A. A communication quality rank is expressed as “radio wave strength” in the figures. From among AP1, AP2, and AP3 that belong to the communication quality rank of “very high”, AP3 that is compatible with Multi-Link is displayed at the top.

As described above, according to the present embodiment, APs are displayed in descending order of the communication quality rank. In addition, Multi-Link compatible APs are displayed so that they are ranked higher than Multi-Link-incompatible APs for each communication quality rank. In other words, for each communication quality rank, Multi-Link compatible APs are displayed in preference to Multi-Link-incompatible APs. As a result, Multi-Link compatible APs with the highest communication quality rank are displayed as the highest priority (at the top) on the AP search result screen. Therefore, even in a case where there are many surrounding APs, the user can be presented with a user interface that makes it possible to more easily look up an AP that has the highest communication quality and is compatible with the Multi-Link function from the AP search results. While the above-description has discussed an example in which Multi-Link compatible APs are displayed so that they are ranked higher than Multi-Link-incompatible APs, no limitation is intended by this configuration as long as Multi-Link compatible APs are preferentially displayed. For example, it is permissible to adopt a configuration in which Multi-Link compatible APs are displayed with emphasis using icons or the like, and it is permissible to adopt a configuration in which Multi-Link compatible APs are displayed as the search results sooner than Multi-Link-incompatible APs. While the above has presented an example in which Multi-Link compatible APs are displayed in preference to Multi-Link-incompatible APs, no limitation is intended by this, and it is permissible to adopt a configuration in which APs that are compatible with the standard of or after the IEEE 802.11be are displayed in preference to APs that are compatible with the standards before the IEEE 802.11be.

While the above embodiment has been described using an example in which the MFP 100 is used, no limitation is intended by this example, and a communication device (electronic device) that connects to an AP and functions as an STA is applicable. A personal computer, a PDA, a tablet terminal, a mobile telephone terminal like a smartphone, a music player, a game device, an electronic book reader, a smartwatch, and various types of measurement apparatuses (sensor apparatuses) like a thermometer and a hygrometer, can be used in place of the MFP 100. A digital camera (including a still camera, a video camera, a network camera, and a security camera), a printer, a scanner, and a drone can also be used in place of the MFP 100. In addition, a video output apparatus, a sound output apparatus (e.g., a smart speaker), a media streaming player, a wireless LAN slave device (adapter) to which a USB terminal and a LAN cable terminal can be connected, and the like can be used in place of the MFP 100. The video output apparatus includes, for example, an apparatus that obtains (downloads) moving images on the Internet specified by an URL designated by an electronic device, and outputs the moving images to a display device connected via a video output terminal, such as HDMI™, thereby realizing streaming reproduction on the display device, and realizing display in the form of mirroring (display whereby the content displayed on the electronic device is also displayed on the display device). The video output apparatus includes a media player like a television receiver, a hard disk recorder, a Blu-ray recorder, and a DVD recorder, a head-mounted display, a projector, a television receiver, a display apparatus (monitor), a signage apparatus, and the like. Devices that are connectable to Wi-Fi® and that are so-called smart household appliances, such as an air conditioner, a refrigerator, a washing machine, a vacuum cleaner, an oven, a microwave oven, a light fixture, a heater, and a cooler, can be used in place of the MFP 100.

It is permissible to adopt a configuration in which the user can set whether to preferentially display Multi-Link-compatible APs on the MFP 100. In this case, for example, in a case where it is determined that the Multi-Link function has been set to be enabled in step S704, the CPU 212 may further determine whether to preferentially display Multi-Link compatible APs based on the foregoing setting. In a case where it is determined that Multi-Link-compatible APs are to be preferentially displayed, processing from step S705 is executed. In a case where it is determined that Multi-Link-compatible APs are not to be preferentially displayed, the CPU 212 executes processing from step S716 even when the Multi-Link function has been set to be enabled.

In the present embodiment, it is permissible to adopt a configuration in which the user can set whether to perform filtering and display only Multi-Link-compatible APs as the search results. In this case, for example, in step S714, the CPU 212 may determine whether to perform filtering and display only Multi-Link-compatible APs as the search results based on the foregoing setting. In a case where it is determined that filtering is to be performed and only Multi-Link-compatible APs are to be displayed as the search results, the CPU 212 performs filtering and displays only Multi-Link-compatible APs as the search results in step S714. Using the example of the present embodiment, among “AP3, AP1, AP2, AP5, AP4, and AP6” in the array I, only Multi-Link-compatible APs, namely “AP3 and AP5”, are displayed as the search results as a result of filtering.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-015775, filed Feb. 5, 2024, which is hereby incorporated by reference herein in its entirety.

What is claimed is:

1. An information processing apparatus that performs wireless communication with an external access point, the information processing apparatus comprising:
at least one memory storing a program; and
at least one processor, that when executing the program, causes the information processing apparatus to:
search for the access point,
display a search result on a display unit,
wherein control is performed to, as part of displaying the search result, display access point information of an access point that has been searched for, and
control is performed to, in a case where a plurality of access points have been searched for, display access point information of an access point that is compatible with a predetermined function complying with a communication standard as the search result in preference to access point information of an access point that is not compatible with the predetermined function.

2. The information processing apparatus according to claim 1, wherein
the at least one processor causes the information processing apparatus to perform control so that the access point information of the access point that is compatible with the predetermined function is displayed to be ranked higher than the access point information of the access point that is not compatible with the predetermined function in the search result.

3. The information processing apparatus according to claim 1, wherein
the at least one processor causes the information processing apparatus to display the access point information of the access point that is compatible with the predetermined function in preference to access point information of an access point that is categorized in a same communication quality rank as the access point that is compatible with the predetermined function and that is not compatible with the predetermined function.

4. The information processing apparatus according to claim 1, wherein
the at least one processor causes the information processing apparatus to, in a case a first access point that is not compatible with the predetermined function has been searched for and that is categorized in a first communication quality rank and a second access point that is compatible with the predetermined function and that is categorized in a second communication quality rank, perform control so that access point information of the second access point is not displayed in preference to access point information of the first access point if the first communication quality rank is higher than the second communication quality rank.

5. The information processing apparatus according to claim 4, wherein
the at least one processor causes the information processing apparatus to perform control so that the access point information of the first access point is displayed in preference to the access point information of the second access point if the first communication quality rank is higher than the second communication quality rank.

6. The information processing apparatus according to claim 4, wherein
the at least one processor causes the information processing apparatus to, in a case where a third access point that is categorized in the first communication quality rank, perform control so that access point information of the third access point is displayed in preference to the access point information of the second access point if the first communication quality rank is higher than the second communication quality rank.

7. The information processing apparatus according to claim 6, wherein
the first communication quality rank and the second communication quality rank correspond to ranges of a radio wave strength.

8. The information processing apparatus according to claim 1, wherein
the at least one processor causes the information processing apparatus to perform control so that the access point information of the access point that is not compatible with the predetermined function is not displayed as the search result.

9. The information processing apparatus according to claim 1, wherein
the at least one processor causes the information processing apparatus to perform control to display the access point information of the access point that has been searched for in a case where the predetermined function is enabled on the information processing apparatus.

10. The information processing apparatus according to claim 9, wherein
the at least one processor causes the information processing apparatus to, in a case where the predetermined function is not enabled on the information processing apparatus, perform control to, based on information of radio wave strengths included in the pieces of access point information, display respective pieces of access point information of the plurality of access points in the search result.

11. The information processing apparatus according to claim 1, wherein
the at least one processor causes the information processing apparatus to set whether to display the access point information of the access point that is compatible with the predetermined function in preference to the access point information of the access point that is not compatible with the predetermined function,
wherein the access point information of the access point that has been searched is displayed in a case where the preferential display has been set.

12. The information processing apparatus according to claim 1, wherein
the at least one processor causes the information processing apparatus to accept a selection of an access point from the displayed search result, and
to provide, in a case where a selection of an access point that is not compatible with the predetermined function is accepted, a notification indicating that the access point is not compatible with the predetermined function.

13. The information processing apparatus according to claim 12, wherein
the at least one processor causes the information processing apparatus to set whether to enable the predetermined function on the information processing apparatus, and
to provide the notification in a case where the predetermined function has been set to be enabled.

14. The information processing apparatus according to claim 12, wherein
the notification is provided in a case where the plurality of access points that have been searched for include an access point that is compatible with the predetermined function.

15. The information processing apparatus according to claim 1, further comprising a print unit.

16. The information processing apparatus according to claim 1, further comprising a read unit.

17. The information processing apparatus according to claim 1, wherein
the predetermined function is a Multi-Link communication function of standards of the IEEE 802.11 series.

18. A method executable on an information processing apparatus that performs wireless communication with an external access point, the method comprising:
searching for the access point;
displaying a search result of the search on a display unit;
wherein control is performed to, as part of displaying the search result, display access point information of an access point that has been searched for; and
control is performed to display, in a case where a plurality of access points have been searched, access point information of an access point that is compatible with a predetermined function complying with a communication standard as a search result in preference to access point information of an access point that is not compatible with the predetermined function.

19. A non-transitory computer-readable storage medium that stores one or more programs that when executed by one or more processors of an information processing apparatus that performs wireless communication with an external access point cause the information processing apparatus to execute a method, the method comprising:
searching for the access point;
displaying a search result of the search on a display unit;
wherein control is performed to, as part of displaying the search result, display access point information of an access point that has been searched for; and
control is performed to display, in a case where a plurality of access points have been searched for, access point information of an access point that is compatible with a predetermined function complying with a communication standard as a search result in preference to access point information of an access point that is not compatible with the predetermined function.
